(19) United States
(12) Patent Application Publication
(10) Pub. No.: US 2018/0266277 A1
(43) Pub. Date: Sep. 20, 2018

(54) Gas Turbine, Guide Blade Ring of a Gas Turbine and Method for Producing the Same

(71) Applicant: MAN DIESEL & TURBO SE, Augsburg (DE)

(72) Inventors: Emil ASCHENBRUCK, Duisburg (DE); Stefan CLAUSS, Duisburg (DE); Andreas KLEINEFELDT, Ratingen (DE); Jaman EL MASALME, Hamminkeln (DE); Michael BLASWICH, Oberhausen (DE)

(21) Appl. No.: 15/922,658

(22) Filed: Mar. 15, 2018

(30) Foreign Application Priority Data
Mar. 17, 2017 (DE) 102017105760.9

(51) Int. Cl. F01D 25/24; F01D 9/04

(52) U.S. Cl. CPC F01D 25/246; B33Y 80/00; F01D 9/042; F01D 9/041

(57) ABSTRACT

A gas turbine with a compressor having stator side guide blades and rotor side moving blades, a burner a combustion chamber; with a turbine); with a diffuser arranged downstream of the compressor, which has an inside wall and an outside wall and; an intermediate housing following the outside wall. An outlet side guide blade ring of stator side, outlet side guide blades (30a) of the compressor has an inner shroud and an outer shroud. First fastening devices are formed on the outer shroud (34) of the guide blade ring via which the guide blade ring is attached to the intermediate housing, second fastening devices are formed, on the inner shroud (33) of the guide blade ring via which the inside wall of the diffuser is directly attached to the guide blade ring.

### BACKGROUND OF THE INVENTION

### 1. Field of the Invention

The invention relates to a gas turbine. The invention, furthermore, relates to an outlet side guide blade ring of stator side guide blades of a compressor of a gas turbine formed as an axial compressor and to a method for producing the same.

### 2. Description of the Related Art

The person skilled in the art addressed here is familiar with the fundamental construction of a gas turbine such as for example an industrial gas turbine. Accordingly, a gas turbine comprises as substantial assemblies a compressor, a burner comprising at least one combustion chamber and a turbine. In the compressor, an air flow is compressed. The air flow compressed in the compressor can be fed to the or each combustion chamber of the gas turbine. In the or each combustion chamber of the gas turbine, a fuel is combusted in the presence of the compressed air as a result of which the air is heated. Emanating from the or each combustion chamber of the turbine, the heated air can be fed to the gas turbine wherein in the turbine the heated air is expanded.

The work output of such a gas turbine is then obtained from the difference of the turbine power output and the total input power of the compressor. This difference is created by the energy input in the or each combustion chamber of the burner.

From EP 2 372 161 B1 a gas turbine with a compressor designed as axial compressor, with a burner comprising at least one combustion chamber and with a turbine is known.

From practice it is known, furthermore, that a gas turbine, downstream of the compressor, comprises a first diffuser and downstream of the turbine a second diffuser to conduct the compressed air via the first diffuser directly downstream of the compressor and with the second diffuser conduct the expanded air directly downstream of the turbine. The first diffuser positioned downstream of the compressor has an inside wall and an outside wall. An intermediate housing of the gas turbine follows the outside wall of this first diffuser.

In gas turbines known from practice, the connection of the diffuser positioned downstream of the compressor to assemblies of the gas turbine on the stator side proves to be difficult. It proves to be difficult, in particular, to attach the inside wall of the diffuser with sufficient quality. The diffuser and adjoining assemblies of the gas turbine on the stator side are exposed to thermal loads, in particular temperature fluctuations, which can cause thermally induced elongations in the connection of the diffuser to the assemblies of the gas turbine on the stator side. Because of this, the quality of the connection of the diffuser to adjoining assemblies of the gas turbine on the stator side can be negatively affected.

### SUMMARY OF THE INVENTION

There is a need to attach the diffuser of a gas turbine, in particular the inside wall of the diffuser, with high quality to an assembly of a gas turbine on the stator side.

One aspect of the invention is based on creating a new type of gas turbine, a guide blade ring of such a gas turbine on the outlet side and a method for producing the same.

An outlet side guide blade ring of guide blades of the compressor on the stator side comprises an inner shroud and an outer shroud. On the outer shroud of the outlet side guide blade ring of the stator side guide blades first fastening devices are formed via which the guide blade ring is directly attached to the intermediate housing. On the inner shroud of the outlet side guide blade ring of the stator side guide blades second fastening devices are formed via which the inside wall of the diffuser is directly attached to the guide blade ring.

In the gas turbine, the outlet side, stator side guide blades provide a guide blade ring with an inner shroud and an outer shroud. On the outer shroud, first fastening devices are formed via which the guide blade ring is directly connected to the intermediate housing. On the inner shroud, second fastening devices are formed via which the inside wall of the diffuser is directly connected to the outlet side guide blade ring. Because of this, the inside wall of the diffuser can be easily connected with high quality to the intermediate housing via the guide blade ring and held in a defined centric position. Temperature-induced elongations in the connection of the inside wall of the diffuser can be reduced.

Preferentially, the outside wall of the diffuser is directly connected to the intermediate housing or is an integral part of the same. Because of this, the connection of the diffuser to stator side assemblies of the gas turbine can be further improved. Here, a risk of temperature-induced elongations is low.

According to a further development, a ratio between a thickness of the stator side guide blades of the outlet side guide blade ring and a thickness of the inner shroud of the guide blade ring and/or a ratio between a thickness of the stator side guide blades of the outlet side guide blade ring and a thickness of the outer shroud of the guide blade ring is greater than or greater than/equal to 1:5.

These ratios of the thickness of the stator side guide blades of the outlet side guide blade ring and the thickness of the shroud of the guide blade ring are preferred in order to ensure a secure connection of the guide blade ring to the intermediate housing and of the inside wall of the diffuser to the guide blade ring.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1 is a gas turbine according to the prior art in cross section;

FIG. 2 is a detail of a gas turbine according to one aspect of the invention in the region of an intermediate housing of the same in cross section;

FIG. 3 is an enlarged detail of FIG. 2;

FIG. 4 is a detail of the gas turbine in perspective view; and

FIG. 5 is an alternative detail of the gas turbine in perspective view.

### DETAILED DESCRIPTION OF THE PRESENTLY PREFERRED EMBODIMENTS

The invention relates to a gas turbine.

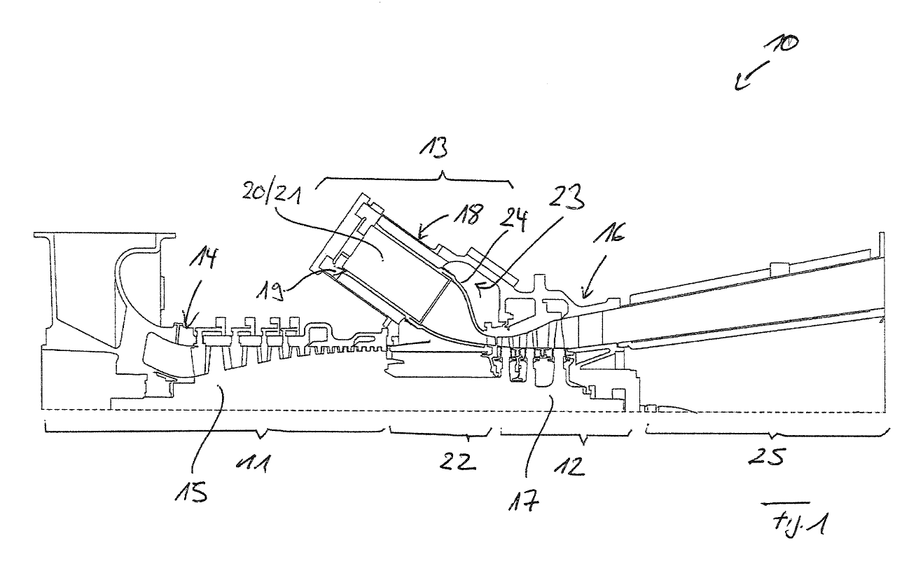

FIG. 1 shows an axial section through a gas turbine 10 in the region of a compressor 11, of a turbine 12 and of a burner 13 comprising at least one combustion chamber, connected between the compressor and the turbine 12. Of the compressor 11, a stator side housing 14 and a rotor side shaft 15 with a plurality of compressor stages are shown. Of the turbine 12, a stator side housing 16 and a rotor side shaft 17 with a plurality of turbine stages are shown. The rotor side shaft 15 of the compressor 11 and the rotor side shaft 17 of the turbine 12 are coupled to one another.

For the burner 13, a burner housing 18 is shown, which is connected between the stator side housing 14 of the compressor 11 and the stator side housing 16 of the turbine 12. Preferentially, the burner housing 18 has a plurality of recesses 19, wherein each recess 19 serves for receiving at least one flame tube 20 of a respective combustion chamber 21. By way of the circumference of the burner housing 18, these recesses 19 for receiving the flame tubes 20 are arranged equally distributed preferentially seen in the circumferential direction.

The compressor 11 serves for compressing an air flow. The compressed air flow leaves the compressor 11 via a diffuser 22 and, via the diffuser 22, enters an annular flow duct 23 which is provided by the burner housing 18. Starting out from this annular flow duct 23 of the burner housing 18, the compressed air enters the region of each combustion chamber 21 and thus the region of each flame tube 20, wherein in the region of the respective combustion chamber 21 a fuel is combusted and the air heated in the process. Starting out from the respective combustion chamber 21, the heated air is fed to the turbine 12, wherein intermediate pieces 24 serve for this purpose. Starting out from each combustion chamber 21, the heated air can be fed to the gas turbine 10 via in each case an intermediate piece 24 of the turbine 12. In the region of the turbine 12 of the gas turbine 10, the heated air is expanded. Downstream of the turbine 12 a further diffuser 25 is arranged via which the expanded air is conducted downstream of the turbine 12.

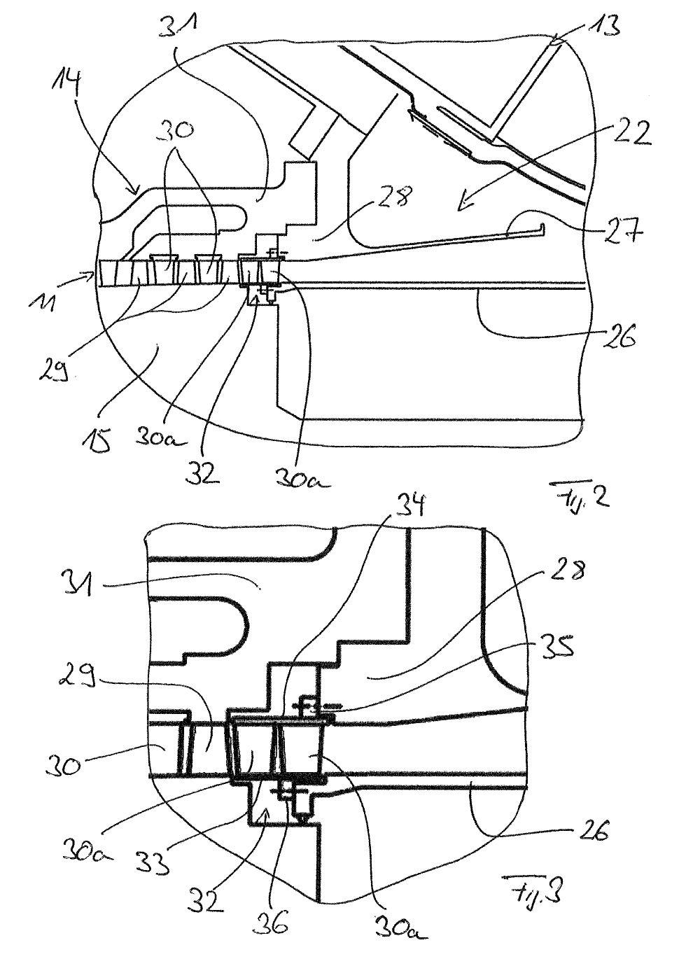

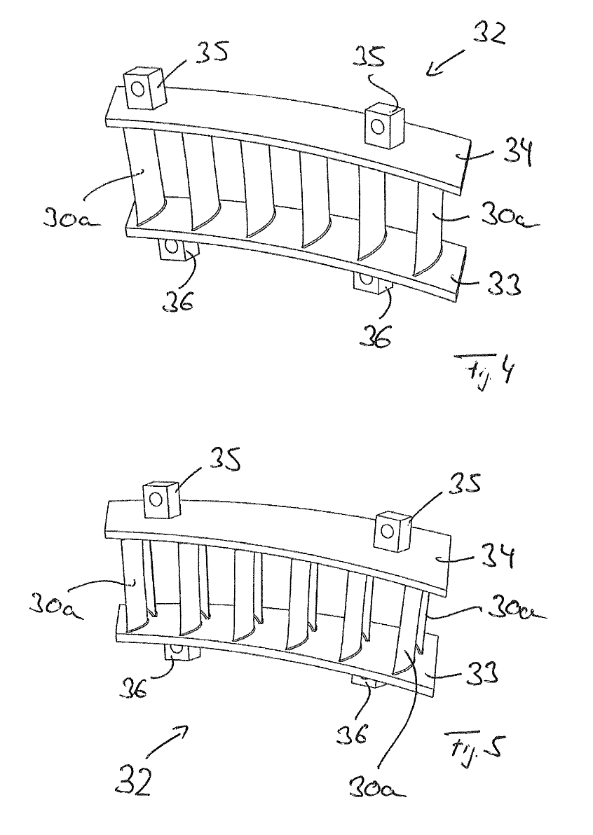

As shown in FIG. 2, the diffuser 22 directly following the compressor 11 comprises a radially inner inside wall 26 and a radially outer outside wall 27, wherein this inside wall 26 and outside wall 27 of the diffuser 22 define a flow duct for the compressed air in the direction of the burner 13. The outside wall 27 of the diffuser 22 is followed by an intermediate housing 28 of the gas turbine.

The compressor 11 is positioned seen in flow direction of the compressed air upstream of the diffuser 22, wherein the compressor 11, as already explained, typically comprises a plurality of stages of rotor side moving blades 29 and stator side guide blades 30. The rotor side moving blades 30 rotate together with the rotor side shaft 15 of the compressor 11, stator side guide blades 30 are attached in a guide blade carrier 31 of the stator side housing 14 of the compressor 11.

In the gas turbine 10 according to one aspect of the invention, the outlet side, stator side guide blades 30a form a ring 32 of guide blades 30a which is also described as outlet side guide blade ring. This outlet side guide blade ring 32 comprises an inner shroud 33 and an outer shroud 34.

On the outer shroud 34 of the outlet side guide blade ring 32, first fastening devices 35 are formed via that the guide blade ring 32 can be directly connected to the intermediate housing 28 or directly attached to the intermediate housing 28.

On the inner shroud 33 of the outlet side guide blade ring 32, second fastening devices 36 are formed via which the inside wall 26 of the diffuser 22 is directly connected to the guide blade ring 32 or can be directly attached to the outlet side guide blade ring 32.

The outside wall 27 of the diffuser 22 can be separately attached to the intermediate housing 28. In the shown exemplary embodiment, the outside wall 27 of the diffuser 22 is an integral part of the intermediate housing 28.

With the gas turbine according to the invention, it is proposed accordingly to combine the outlet side guide blades 30a in a separate guide blade ring 32 comprising an inner shroud 33 and an outer shroud 34, wherein this guide blade ring 32 is directly connected to the intermediate housing 28 via the first fastening devices 35 of the outer shroud 34, and wherein the inside wall 26 of the diffuser 22 is directly connected to the fastening devices 36 of the inner shroud 33 of the outlet side guide blade ring 32. By way of this, an optimal connection of the diffuser 22 to stator side assemblies, namely to the intermediate housing 28 can be provided.

The stator side guide blades 30 of the guide blade ring 32 together with the inner shroud 33, the outer shroud 34 and the first and second fastening devices 35, 36 form a monolithic assembly.

FIG. 5 shows an embodiment in which the guide blades 30a of the outlet side guide blade ring 32 form a tandem arrangement. Two such outlet side guide blades 30a in each case form a tandem arrangement consisting of guide blades 30a arranged in the axial direction directly one behind the other.

According to an advantageous further development of the invention it is provided that a ratio between a thickness of the stator side guide blades 30a of the outlet side guide blade ring 32 and a thickness of the inner shroud 33 of the same is greater or greater than/equal to 1:5. Furthermore, a ratio between the thickness of the stator side guide blades 30a and a thickness of the outer shroud 34 of the outlet side guide blade ring 32 is also greater or greater than/equal to 1:5.

The thickness of the respective shroud 33, 34 is the distance between two boundary surfaces of the respective shroud seen in radial direction.

The thickness of the respective stator side guide blade 30a of the outlet side guide blade ring 32 is a maximum distance between a suction side and a pressure side of the respective guide blades 30a.

In particular when the guide blades 30a of the outlet side guide blade ring 32 are embodied in tandem arrangement it can be provided to produce the monolithic assembly of the outlet side guide blade ring 32 by way of a generative or additive production method, in particular via 3D printing. The person skilled in the art addressed here is familiar with details of such generative production methods.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A gas turbine, comprising:
an axial compressor configured to compress air, comprising:
stator side guide blades; and
rotor side moving blades;
a burner comprising at least one combustion chamber, to which air compressed in the axial compressor is fed and in which a fuel can be combusted in with the compressed air, subject to heating the air;
a turbine configured to expand the heated air;
a diffuser arranged downstream of the turbine, as seen in a flow direction of the compressed air, the diffuser comprising:
an inside wall; and
an outside wall;
an intermediate housing following the outside wall of the diffuser;
an outlet side guide blade ring of a stator side, comprises:
outlet side guide blades of the compressor;
an inner shroud; and
an outer shroud;
first fastening devices formed on the outer shroud of the outlet side guide blade ring of the stator side guide blades via which the guide blade ring is directly attached to the intermediate housing; and
second fastening devices formed on the inner shroud of the outlet side guide blade ring of the stator side guide blades via which the inside wall of the diffuser is directly attached to the guide blade ring.

2. The gas turbine according to claim 1, wherein the outside wall of the diffuser is one of:
directly connected to the intermediate housing and
is an integral part of the intermediate housing.

3. The gas turbine according to claim 1, wherein two stator side guide blades of the outlet side guide blade ring form a tandem arrangement.

4. The gas turbine according to claim 1, wherein a ratio between a thickness of the stator side guide blades of the outlet side guide blade ring and a thickness of the inner shroud of the guide blade ring is greater than or equal to 1:5.

5. The gas turbine according to claim 1, wherein a ratio between a thickness of the stator side guide blades of the outlet side guide blade ring and a thickness of the outer shroud of the guide blade ring is greater than or equal to 1:5.

6. The gas turbine according to claim 4, wherein the thickness of each stator side guide blade of the outlet side guide blade ring is defined by a maximum distance between a suction side and a pressure side of the respective guide blade, and the thickness of the respective shroud of the outlet side guide blade ring is defined by a distance between two boundary surfaces of the respective shroud in a radial direction of the guide blade ring.

7. The gas turbine according to claim 1, wherein a monolithic assembly is formed by:
the stator side guide blades of the outlet side guide blade ring,
the inner shroud,
the outer shroud,
the first fastening devices, and
the second fastening devices.

8. The gas turbine according to claim 7, wherein the monolithic assembly is produced via a generative production method.

9. The gas turbine according to claim 8, wherein the generative production method is 3D printing.

10. The gas turbine according to claim 5, wherein the thickness of each stator side guide blade of the outlet side guide blade ring is defined by a maximum distance between a suction side and a pressure side of the respective guide blade, and the thickness of the respective shroud of the outlet side guide blade ring is defined by a distance between two boundary surfaces of the respective shroud in a radial direction of the guide blade ring.

11. An outlet side guide blade ring of stator side guide blades of an axial compressor of a gas turbine, comprising:
an inner shroud and an outer shroud;
first fastening devices are formed on the outer shroud via which the guide blade ring is configured to be directly attached to an intermediate housing of the gas turbine;
second fastening devices are formed on the inner shroud via which an inside wall of a diffuser of the gas turbine is configured to be directly attached to the guide blade ring.

12. A method for producing a guide blade ring of stator side guide blades of an axial compressor of a gas turbine, having:
an inner shroud and an outer shroud;
first fastening devices are formed on the outer shroud via which the guide blade ring is configured to be directly attached to an intermediate housing of the gas turbine;
second fastening devices are formed on the inner shroud via which an inside wall of a diffuser of the gas turbine is configured to be directly attached to the guide blade ring,
the method comprising:
providing a material;
producing the guide blade ring as monolithic assembly via a generative production method.

13. The method according to claim 12, wherein the generative production method is 3D printing.
